(19) United States
(12) Patent Application Publication
(10) Pub. No.: US 2014/0184031 A1
(43) Pub. Date: Jul. 3, 2014

(54) ROTARY ELECTRIC MACHINE

(71) Applicant: Keiichi Kaneshige, Seto-shi Aichi-ken (JP)

(72) Inventor: Keiichi Kaneshige, Seto-shi Aichi-ken (JP)

(73) Assignee: TOYOTA JIDOSHA KABUSHIKI KAISHA, Toyota-shi Aichi-ken (JP)

(21) Appl. No.: 14/239,959

(22) PCT Filed: Aug. 23, 2012
(86) PCT No.: PCT/IB2012/001625

§ 371 Date: Feb. 20, 2014

(30) Foreign Application Priority Data
Aug. 31, 2011 (JP) 2011-188133

(51) Int. Cl. H02K 11/00

(52) U.S. Cl. CPC H02K 11/0047
USPC 310/68 B

(57) ABSTRACT

A rotary electric machine includes: a stator core fixed to a casing; a coil end formed on the stator core; a bracket fixed to the casing; an arm that extends from the bracket and that is made of metal and that has elasticity; a holder that is attached to the arm and that is made of resin; and a sensor that is attached to the holder and that contacts the coil end to detect temperature of the coil end.

### BACKGROUND OF THE INVENTION

1. Field of the Invention

The invention relates to a structure of a stator of a rotary electric machine.

2. Description of Related Art

Rotary electric machines, such as electric motors and the like, produce heat when in operation. In particular, when the load of a rotary electric machine becomes excessively large, there is a possibility of a great increase of the temperature of the coils. Therefore, a temperature sensor is attached to the coils so as to monitor the temperature of the coils.

The methods proposed for attaching a temperature sensor to the coils include a method in which guides having a D-shaped cross section made of resin are inserted into tunnel-shaped spaces in a coil end formed between slots of the stator core so that the temperature detection element of the sensor is pressed against the surface of the coil end by the guides (see, e.g., Japanese Patent Application Publication No. 2003-92858 (JP 2003-92858 A)). There also exists a method in which a temperature sensor is attached to a bracket via sponge pieces or hollow rubber pieces so that when the bracket is incorporated into a casing, the temperature sensor is pressed against the surface of the coil end (see, e.g., Japanese Patent Application Publication No. 2003-32964 (JP 2003-32964 A)). There is still another method in which a temperature sensor is attached to a coil end-side surface of a neutral-point case made of resin that is attached to the coil end, and when the neutral-point case is attached to the coil end via a band made of resin, the temperature sensor is pressed, by tension of the band, against the surface of the coil end (see, e.g., Japanese Patent Application Publication No. 2008-29127 (JP 2008-29127 A)). Yet another method proposed is, among other methods, a method in which when the coil is molded, a recess portion is formed on the surface of the coil end by a dummy member, and a temperature sensor is attached to the recess portion so as to measure the temperature of the coil end (see, e.g., Japanese Patent Application Publication No. 2008-22679 (JP 2008-22679 A)).

However, as for the related arts described in JP 2003-92858 A, JP 2003-32964 A and JP 2008-29127 A, although the arts are designed so that the temperature of the coil end is measured in an arrangement in which the temperature sensor is pressed against the surface of the coil end by utilizing the elasticity of the resin, the resin degrades due to high temperature within the rotary electric machines, such as electric motors and the like, during operation, or resin component parts deform due to creep that occurs as stressed state continues. Therefore, it is impossible to stably press the temperature sensor against the coils for a long period of time. This results in a time-dependent problem of possibly making an error in detecting the temperature.

In the related art described in JP 2008-22679 A, when the coil end is to be molded, a dummy is inserted so as to form the recess portion in the coil end, and the temperature sensor is attached to the recess portion. However, it is labor-consuming to insert and remove the dummy, and it is not easy to replace the temperature sensor at the time of failure since the temperature sensor is set in the recess portion. Therefore, the range of application of this related art is limited.

In the method in which the temperature sensor is pressed against the coil end by utilizing the elasticity of metal, degradation of the metal is small, and therefore it is possible to stably press the temperature sensor against the surfaces of the coils for a long period of time. However, since metal component parts have high heat conductivity, the ambient temperature, for example, the temperature of cooling oil, the temperature of air inside the casing, etc., is conducted to the temperature sensor, giving rise to a problem of the ambient environment causing an error in the output of the temperature sensor.

### SUMMARY OF THE INVENTION

The invention provides a construction that stably measures the temperature of coils for a long period of time.

A rotary electric machine in accordance with an aspect of the invention includes: a stator core fixed to a casing; a coil end formed on the stator core; a bracket fixed to the casing; an arm that extends from the bracket and that is made of metal and that has elasticity; a holder that is attached to the arm and that is made of resin; and a sensor that is attached to the holder and that contacts the coil end to detect temperature of the coil end.

In the rotary electric machine of the foregoing aspect of the invention, the arm may extend from the bracket toward an outer peripheral surface of the coil end, and the sensor may contact the outer peripheral surface of the coil end to detect the temperature of the coil end.

In the rotary electric machine of the aspect of the invention, the coil end may be annular, and the arm may press the sensor against the coil end in a radial direction of the coil end.

In the rotary electric machine of the aspect of the invention, the arm may be connected to the holder so as to press a temperature detection site of the sensor against the outer peripheral surface of the annular coil end, toward a center of the coil end, the temperature detection site of the sensor being a site of the sensor that detects the temperature.

In the rotary electric machine of the aspect of the invention, the holder may hold the sensor so that a temperature detection site of the sensor which is a site of the sensor that detects the temperature is located at a first surface of an end-side portion of the holder in a circumferential direction of the coil end, the first surface facing the coil end, and the arm may be connected to a second surface of the end-side portion of the holder which is opposite to the first surface of the end-side portion of the holder.

In the rotary electric machine of the aspect of the invention, the arm and the sensor may be thermally insulated from each other by the holder.

In the rotary electric machine of the aspect of the invention, the holder may surround the sensor so that a side portion of the sensor that faces the coil end is exposed.

In the rotary electric machine of the aspect of the invention, the holder may surround the sensor so as to cover a portion of the sensor which does not contact the coil end.

In the rotary electric machine, the sensor may be a thermistor.

According to the invention, it is possible to stably measure the coil temperature for a long period of time.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing a construction of a stator in an embodiment of the invention;

FIG. 2 is a plan view of the stator in the embodiment of the invention; and

FIG. 3 is a sectional view taken along line of FIG. 2.

### DETAILED DESCRIPTION OF EMBODIMENTS

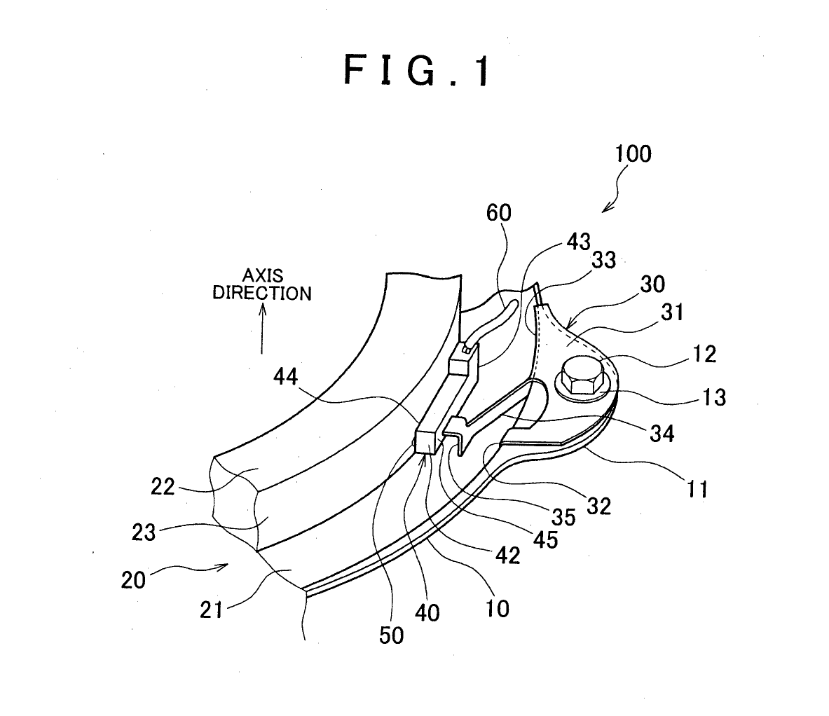

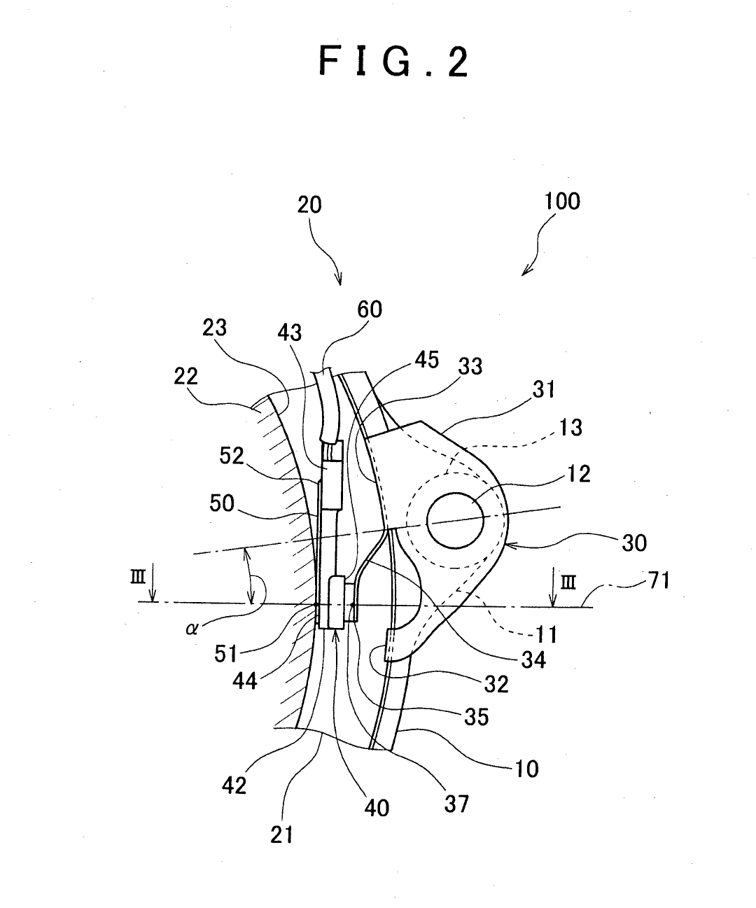

Hereinafter, embodiments of the invention will be described with reference to the drawings. As shown in FIG. 1, a rotary electric machine 100 in accordance with an embodiment of the invention includes a stator 20, a bracket 30 and a thermistor holder 40. The stator 20 is fixed inside a casing 10. The bracket 30 is attached to a fixture portion 11 of the casing 10, and is made of metal. The thermistor holder 40 is attached to a distal end 35 of an arm 34 provided on the bracket 30, and is made of resin. The stator 20 includes a stator core 21, coils and a coil end 22. The stator core 21 is fixed to an internal surface of the casing 10. The coils are wound on the stator core 21. The stator core 21 is provided with the coil end 22. The coil end is formed on an axis-direction end surface of the stator core 21 due to the winding of the coils. A sectional shape of the coil end 22 is semi-circular or rectangular. The bracket 30 includes a main body 31 and the arm 34 that obliquely extends from the main body 31 toward an outside surface 23 of the coil end 22. That is, the arm 34 extends toward the outside surface 23 that is an outer peripheral surface of the coil end that is formed so as to have an annular shape. The main body 31 of the bracket 30 is a thin metal plate that has a semi-circular shape, and is provided with bent hooks 32 and 33 that are bent toward an inner peripheral surface of the casing 10. The main body 31 is fixed to the fixture portion 11 of the casing 10 by hooking the bent hooks 32 and 33 on the inner peripheral surface of the casing 10 and tightening a bolt 12 via a washer 13. The arm 34 is a thin metal band plate continuous from the bent hook 33, and extends obliquely toward the outside surface 23 of the coil end 22 from a position at an angle a in the counterclockwise direction from a horizontal axis 71 of the rotary electric machine 100 as shown in FIG. 2. A center 37 of the distal end 35 reaches the horizontal axis 71. The arm 34 is made of metal, and is elastic.

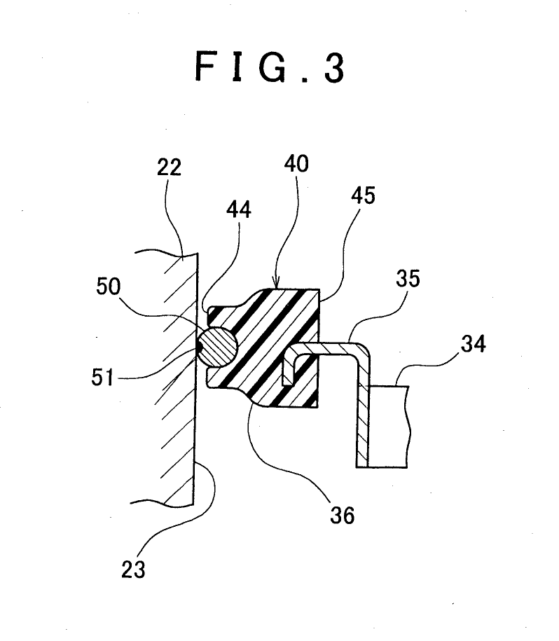

As shown in FIG. 3, the distal end 35 of the arm 34 is connected to the thermistor holder 40 made of resin, by insert molding. As shown in FIG. 2, the thermistor holder 40 is a generally rectangular parallelepiped in shape, and a bar-shaped thermistor 50 is attached to a coil end 22 side of the holder 40. A temperature detection site 51 of the thermistor 50 that is a site that detects temperature is at the side of an end 42 of the thermistor holder 40, and is disposed so as to contact the outside surface 23 of the coil end 22 at the position of the horizontal axis 71 of the rotary electric machine 100. Therefore, the center 37 of the distal end 35 of the arm 34 and the temperature detection site 51 of the thermistor 50 are both constructed so as to be located on the horizontal axis 71 of the rotary electric machine 100. That is, the thermistor holder 40 holds the thermistor 50 so that, in an end 42-side portion of the thermistor holder 40, the temperature detection site 51 of the thermistor 50 is positioned at a surface 44 that faces the outside surface 23 of the coil end 22. The elastic arm 34 made of metal is connected to a surface 45 of the end 42-side portion of the thermistor holder 40 which is opposite to the surface 44 of the thermistor holder 40 which faces the outside surface 23 of the coil end 22. The center 37 of the distal end 35 of the arm 34 and the temperature detection site 51 of the thermistor 50 are both constructed so as to be located on the horizontal axis 71 of the rotary electric machine 100. Furthermore, at the side of a base 43 of the thermistor holder 40, there is disposed a base portion 52 of the bar-shaped thermistor 50. An output line 60 that outputs a temperature detection signal is connected to the base portion 52 of the thermistor 50, that is, extends therefrom upward in FIG. 2.

As shown in FIG. 3, the thermistor holder 40 surrounds the thermistor 50 so as to cover portions of the thermistor 50 that do not contact the outside surface 23 of the coil end 22. Therefore, the thermistor 50 is surrounded by the resin of the thermistor holder 40, except that only a side portion of the thermistor 50 that faces the coil end 22 is exposed.

In the rotary electric machine 100 constructed as described above, when the bracket 30 is fixed to the fixture portion 11 of the casing 10 by the bolt 12, the temperature detection site 51 of the thermistor 50 contacts the outside surface 23 of the coil end 22, so that the arm 34 flexes or yields toward the main body 31 of the bracket 30. Due to the reaction force that results from the deformation of the flexure, the arm 34 presses the temperature detection site 51 of the thermistor 50 against the outside surface 23 of the coil end 22. Since the arm 34 is made of metal, the elasticity of the arm 34 does not undergo time-dependent degradation, so that the arm 34 is able to stably press the temperature detection site 51 of the thermistor 50 against the outside surface 23 of the coil end 22 over a long period of time. Furthermore, the pressing position remains stable, that is, does not deviate, for a long time, so that the temperature of the outside surface 23 of the coil end 22 can be stably detected.

Furthermore, as shown in FIG. 3, the arm 34 is set in the thermistor holder 40 by insert molding so that a layer of resin of the thermistor holder 40 intervenes between the thermistor 50 and the arm 34. Therefore, heat conducted through the arm 34 of the bracket 30 to the distal end 35 is insulated by the resin layer of the thermistor holder 40, and is therefore not conducted from the distal end 35 of the arm 34 to the thermistor 50. Thus, the thermistor 50 can be substantially kept from being affected by the temperature of the casing 10 or the like.

Furthermore, the thermistor 50 is surrounded by the resin of the thermistor holder 40 except that only the side portion of the thermistor 50 that faces the coil end 22 is exposed. Therefore, the temperature detection site 51 of the thermistor 50 can be kept from being splashed with or exposed to cooling oil or the like. Therefore, false detection of the temperature caused by the cooling oil can be restrained.

Furthermore, since the center 37 of the distal end 35 of the arm 34 and the temperature detection site 51 of the thermistor 50 are both constructed so as to be located on the horizontal axis 71 of the rotary electric machine 100 as shown in FIG. 2, the arm 34 is able to press the temperature detection site 51 of the thermistor 50 against the coil end 22, toward the center of the annular coil end 22, and therefore is able to hold the thermistor 50 so that the temperature detection site 51 of the thermistor 50 does not depart from the outside surface 23 of the coil end 22. Furthermore, since the depressing force by the arm 34 does not bring about a bending stress in the thermistor holder 40 due to the above-described structure, occurrence of deformation of the thermistor holder 40 resulting from the pressing force is restrained.

Although the construction in which the temperature detection site 51 of the thermistor 50 is disposed so as to contact the outside surface of the annular coil end 22 and in which the arm 34 presses the temperature detection site 51 against the outside surface 23 toward the center of the coil end 22 has been described as an example, the invention of this application is not limited to that construction. For example, the thermistor 50 may be disposed so as to contact the inner peripheral surface of the annular coil end 22, that is, an inside surface thereof, and may also be disposed so as to contact an end surface of the coil end 22 which is perpendicular to the outside surface 23. Incidentally, in the case of the construction in which the thermistor 50 contacts the inside surface of the coil end 22, a construction is adopted in which the thermistor 50 is pressed by the arm 34 in a radial direction of the coil end 22 from the inside surface toward the outside surface of the coil end 22.

Furthermore, while the foregoing description has been made in conjunction with the example that adopts the thermistor 50 as a sensor that detects the temperature of the coil end 22, this is not restrictive. For example, such a sensor may be provided by using a bimetal, a thermoelectric couple, etc.

While the disclosure has been explained in conjunction with specific exemplary embodiments thereof, it is evident that many alternatives, modifications, and variations will be apparent to those skilled in the art. Accordingly, exemplary embodiments of the disclosure as set forth herein are intended to be illustrative, not limiting. There are changes that may be made without departing from the scope of the disclosure.

1. A rotary electric machine comprising:
a stator core fixed to a casing;
a coil end formed on the stator core;
a bracket fixed to the casing;
an arm that extends from the bracket and that is made of metal and that has elasticity;
a holder that is attached to the arm and that is made of resin; and
a sensor that is attached to the holder and that contacts the coil end to detect temperature of the coil end.

2. The rotary electric machine according to claim 1, wherein:
the arm extends from the bracket toward an outer peripheral surface of the coil end; and
the sensor contacts the outer peripheral surface of the coil end and detects the temperature of the coil end.

3. The rotary electric machine according to claim 1, wherein:
the coil end is annular;
the arm presses the sensor against the coil end in a radial direction of the coil end.

4. The rotary electric machine according to claim 3, wherein the arm is connected to the holder so as to press a temperature detection site of the sensor against the outer peripheral surface of the annular coil end, toward a center of the coil end, the temperature detection site of the sensor being a site of the senor that detects the temperature.

5. The rotary electric machine according to claim 1, wherein
the holder holds the sensor so that a temperature detection site of the sensor which is a site that detects the temperature is located at a first surface of an end-side portion of the holder in a circumferential direction of the coil end, the first surface facing the coil end, and the arm is connected to a second surface of the end-side portion of the holder which is opposite to the first surface of the end-side portion of the holder.

6. The rotary electric machine according to claim 5, wherein
the arm and the sensor are thermally insulated from each other by the holder.

7. The rotary electric machine according to claim 3, wherein
the holder surrounds the sensor so that a side portion of the sensor that faces the coil end is exposed.

8. The rotary electric machine according to claim 3, wherein
the holder surrounds the sensor so as to cover a portion of the sensor which does not contact the coil end.

9. The rotary electric machine according to claim 1, wherein
the sensor is a thermistor.
